(19) United States
(12) Patent Application Publication
(10) Pub. No.: US 2026/0240210 A1
(43) Pub. Date: Aug. 20, 2026

(54) FLAVOR COMPOSITION AND FOOD OR BEVERAGE TO WHICH FLAVOR COMPOSITION IS ADDED

(71) Applicant: MIYOSHI OIL & FAT CO.,LTD., Tokyo (JP)

(72) Inventors: Ayaka OKUNO, Tokyo (JP); Kazuhiro HAMAMOTO, Tokyo (JP); Masaki ITOH, Tokyo (JP); Keisuke UOZUMI, Tokyo (JP); Yusuke TOMITA, Tokyo (JP); Kimiko SAITO, Tokyo (JP); Akira OHTA, Tokyo (JP); Masanori SHIDA, Tokyo (JP)

(73) Assignee: MIYOSHI OIL & FAT CO.,LTD., Tokyo (JP)

(21) Appl. No.: 19/161,496

(22) PCT Filed: Sep. 22, 2023
(86) PCT No.: PCT/JP2023/034475

§ 371 Date: Sep. 2, 2025

(30) Foreign Application Priority Data
Mar. 8, 2023 (JP) 2023-035235

(51) Int. Cl. A23L 27/26; A23L 27/00; A23L 27/20

(52) U.S. Cl. CPC A23L 27/26; A23L 27/2028; A23L 27/2052; A23L 27/2054; A23L 27/84

(57) ABSTRACT

Provided is a flavor composition to which a flavor of grilled chicken skin is imparted. The flavor composition according to the present invention contains methyl 2-methyl-3-furyl disulfide and 2-acetylpyrrole, wherein the mass ratio of the content of 2-acetylpyrrole to the content of methyl 2-methyl-3-furyl disulfide is in a range from 0.001 to 1,000.

### TECHNICAL FIELD

The present invention relates to a flavor composition.

### BACKGROUND ART

In recent years, there has been growing interest in developing truly sustainable food production systems across the globe to achieve the so-called “Sustainable Development Goals (SDGs),” for which “alternative meats” or “cultured meats” have received particular attention. Recently, the markets for alternative meats and various seasoning products have continued to grow, where such alternative meats and various seasoning products are made from plant-based ingredients which accommodate a whole variety of lifestyles of, for example, flexitarians, vegetarians and vegans.

The vegan market is particularly fast-growing. Therefore, there is a strong demand for imparting a meaty flavor without using animal-based ingredients, and a seasoning product with a meaty flavor is expected to be in growing demand in the future because such a product is capable of imparting a flavor or a cooked taste to a food product.

A flavored oil is known as a condiment for enhancing the tastes of various food or beverage products including the above-mentioned meat substitutes.

The “flavored oil” is also termed flavoring oil, and a well-known example of which includes an oil to which a desired flavor (such as a flavor of green onion or garlic) is imparted. However, no product has ever successfully captured the flavor of fully grilled chicken skin.

Meanwhile, as a method for imparting meat flavor without using any animal-based ingredients (such as animal meat, animal meat-derived ingredients, animal oils/fats, milk components, and eggs), there is proposed a meat flavor composition prepared by incorporating at least one fragrance selected from the group consisting of: (A) pyrroles, (B) pyridines, (C) pyrazines, (D) oxazoles, (E) oxazolines, (F) amines, (G) thiazoles, (H) thiazolines, (I) thiazolidines, (J) thiols, (K) sulfides, (L) thioethers, (M) sulfur-containing carboxylic acids, (N) quinoxalines, and (O) furanones (Patent document 1). However, this document has not successfully conveyed the flavor of grilled chicken skin.

### PRIOR ART DOCUMENTS

### Patent Documents

Patent document 1: JP-A-2005-15683

### SUMMARY OF INVENTION

### Technical Problem

The present invention was made in view of the above circumstances, and it is an object of the present invention to provide a flavor composition to which a flavor of grilled chicken skin is imparted.

### Solution to Problem

The inventors of the present invention diligently conducted a series of studies to solve the above problems, and found out that a composition containing a combination of multiple of specific aroma components can impart the flavor of grilled chicken skin, thus completing the present invention.

Specifically, the flavor composition of the present invention contains methyl 2-methyl-3-furyl disulfide and 2-acetylpyrrole, wherein the mass ratio of the content of 2-acetylpyrrole to the content of methyl 2-methyl-3-furyl disulfide is in a range from 0.001 to 1,000. The food or drink according to the present invention contains said flavor composition.

### Advantageous Effects of Invention

The present invention provides a flavor composition to which a flavor of grilled chicken skin is imparted.

### DESCRIPTION OF EMBODIMENTS

Specific embodiments of the present invention will be described below.

### <Flavor Composition>

The flavor composition of the present invention contains methyl 2-methyl-3-furyl disulfide and 2-acetylpyrrole.

The flavor composition of the present invention may be in any form which is not particularly limited but it is preferred that the composition be an oil/fat component containing an oil/fat, more preferably a flavoring oil (also referred to as “flavor oil”) which is an oil/fat to which a flavor is imparted. The flavor composition of the present invention may be a seasoning product.

The inventors studied various aroma components and consequently found out that a composition containing both methyl 2-methyl-3-furyl disulfide and 2-acetylpyrrole successfully imparts a flavor of grilled chicken skin.

The term “flavor of grilled chicken skin” as used herein refers to a flavor of chicken skin grilled over an open flame.

The presence or intensity of this type of flavor can be assessed using the method outlined in the Examples.

The flavor composition of the present invention may also have a favorable chicken scent.

The term “chicken scent” as used herein refers to a flavor associated with a scent of both animal and oil.

The presence or intensity of this type of flavor can be assessed using the method outlined in the Examples.

The flavor composition of the present invention may also have a favorable meaty flavor.

The term “meaty flavor” as used herein refers to a flavor that reminds oneself of cooked meat (roasted, stir-fried, or grilled meat).

The presence or intensity of this type of flavor can be assessed using the method outlined in the Examples.

The flavor composition of the present invention will be specifically described below.

(Methyl 2-methyl-3-furyl disulfide)

The flavor composition of the present invention contains methyl 2-methyl-3-furyl disulfide (Chemical formula: C₆H₈OS₂, CAS No.: 65505-17-1). Methyl 2-methyl-3-furyl disulfide is also termed, for example, as 2-Methyl-3-(methyldithio) furan.

The flavor composition of the present invention may contain any amount of methyl 2-methyl-3-furyl disulfide which can be suitably adjusted according to, for example, an intended concentration of the flavor.

Regarding the lower limit of the content of methyl 2-methyl-3-furyl disulfide in the flavor composition of the present invention, it is preferred in terms of sufficiently imparting a flavor of grilled chicken skin and meaty flavor that the content be 0.001 ppb or higher, more preferably 0.01 ppb or higher, even more preferably 0.1 ppb or higher, and particularly preferably 1 ppb or higher.

Regarding the upper limit of the content of methyl 2-methyl-3-furyl disulfide in the flavor composition of the present invention, it is preferred in terms of potency and cost effectiveness of the flavor composition that the content be 100 ppb or lower, more preferably 50 ppb or lower, even more preferably 10 ppb or lower, and particularly preferably 1 ppb or lower.

The methyl 2-methyl-3-furyl disulfide of the present invention may be either synthetically produced or derived from, for example, food, beverages or extract which contains methyl 2-methyl-3-furyl disulfide as one of its components.

The amount of methyl 2-methyl-3-furyl disulfide contained in the flavor composition may be determined using gas chromatography SPME (solid phase microextraction) based on a method, called the standard addition method, to be explained in the following.

First, methyl 2-methyl-3-furyl disulfide is added to samples (flavor compositions) so that they have concentrations of 0.01 ppm, 0.1 ppm, 0.5 ppm, 1 ppm, 10 ppm, and 50 ppm to prepare standard samples. They are subjected to gas chromatography in addition to the flavor compositions, and the peak area of ion mass 160 (molecular ion) is measured to create a calibration curve. The retention time is also recorded. The resultant calibration curve may be used to determine the content of methyl 2-methyl-3-furyl disulfide in the flavor composition.

### (2-Acetylpyrrole)

The flavor composition of the present invention contains 2-acetylpyrrole (Chemical formula: C₆H₇NO, CAS No.: 1072-83-9). 2-Acetylpyrrole is also termed, for example, as 1-(1H-pyrrol-2-yl)ethanone.

The flavor composition of the present invention may contain any amount of 2-acetylpyrrole, which can be suitably adjusted according to, for example, an intended concentration of the flavor.

Regarding the lower limit of the content of 2-acetylpyrrole in the flavor composition of the present invention, it is preferred in terms of sufficiently imparting a flavor of grilled chicken skin and meaty flavor that the content be 0.01 ppb or higher, more preferably 0.1 ppb or higher, even more preferably 1 ppb or higher, particularly preferably 10 ppb or higher, and more particularly preferably 100 ppb or higher.

Regarding the upper limit of the content of 2-acetylpyrrole in the flavor composition of the present invention, it is preferred in terms of preventing production of burnt odor in the flavor composition that the content be 100 ppb or lower, more preferably 50 ppb or lower, even more preferably 10 ppb or lower, and particularly preferably 1 ppb or lower. When a burnt odor occurs, it tends to be difficult to sense the flavor of grilled chicken skin and the meaty flavor.

The 2-acetylpyrrole of the present invention may be either synthetically produced or derived from, for example, food, beverage or extract which contains 2-acetylpyrrole as one of its components.

The amount of 2-acetylpyrrole contained in the flavor composition may be determined using gas chromatography SPME (solid phase microextraction) based on a method, called the standard addition method, to be explained in the following.

First, 2-acetylpyrrole is added to samples (flavor compositions) so that they have concentrations of 0.01 ppm, 0.1 ppm, 0.5 ppm, 1 ppm, 10 ppm, and 50 ppm for preparation. They are subjected to gas chromatography in addition to the flavor compositions, and the peak area of ion mass 109.1 (molecular ion) is measured to create a calibration curve. The retention time is also recorded. The resultant calibration curve may be used to determine the content of 2-acetylpyrrole in the flavor composition.

### (2-Methylbutanal)

It is preferred that the flavor composition of the present invention contain not only methyl 2-methyl-3-furyl disulfide and 2-acetylpyrrole but also 2-methylbutanal (Chemical formula: C₅H₁₀O, CAS No.: 96-17-3). 2-Methylbutanal is also termed 2-methylbutyraldehyde.

The 2-methylbutanal according to the present invention may further enhance the chicken scent without impairing the flavor of grilled chicken skin that is brought by methyl 2-methyl-3-furyl disulfide and 2-acetylpyrrole.

The flavor composition of the present invention may contain any amount of 2-methylbutanal, which can be suitably adjusted according to, for example, an intended concentration of the flavor.

Regarding the lower limit of the content of 2-methylbutanal in the flavor composition of the present invention, it is preferred in terms of readily obtaining a sufficient level of chicken scent that the content be 0.1 ppb or higher, more preferably 1 ppb or higher, even more preferably 10 ppb or higher, and particularly preferably 100 ppb or higher.

Regarding the upper limit of the content of 2-methylbutanal in the flavor composition of the present invention, it is preferred in terms of flavor balance and cost effectiveness that the content be 300 ppb or lower, more preferably 100 ppb or lower, even more preferably 50 ppb or lower, and particularly preferably 10 ppb or lower.

The 2-methylbutanal of the present invention may be either synthetically produced or derived from, for example, food, beverage or extract which contains 2-methylbutanal as one of its components.

The amount of 2-methylbutanal contained in the flavor composition may be determined using gas chromatography SPME (solid phase microextraction) based on a method, called the standard addition method, to be explained in the following.

First, 2-methylbutanal is added to samples (flavor compositions) so that they have concentrations of 0.01 ppm, 0.1 ppm, 0.5 ppm, 1 ppm, 10 ppm, and 50 ppm to prepare standard samples. They are subjected to gas chromatography in addition to the flavor compositions, and the peak area of ion mass 57 (molecular ion) is measured to create a calibration curve. The retention time is also recorded. The resultant calibration curve may be used to determine the content of 2-methylbutanal in the flavor composition.

### (3-Methylbutanal)

It is preferred that the flavor composition of the present invention contain not only methyl 2-methyl-3-furyl disulfide and 2-acetylpyrrole but also 3-methylbutanal (Chemical formula: C₅H₁₀O, CAS No.: 590-86-3). 3-Methylbutanal is also termed isovaleraldehyde. The 3-methylbutanal according to the present invention may further enhance the chicken scent without impairing the flavor of grilled chicken skin that is brought by methyl 2-methyl-3-furyl disulfide and 2-acetylpyrrole.

The flavor composition of the present invention may contain any amount of 3-methylbutanal, which can be suitably adjusted according to, for example, an intended concentration of the flavor.

Regarding the lower limit of the content of 3-methylbutanal in the flavor composition of the present invention, it is preferred in terms of readily obtaining a sufficient level of chicken scent that the content be 0.1 ppb or higher, more preferably 1 ppb or higher, even more preferably 10 ppb or higher, and particularly preferably 100 ppb or higher.

Regarding the upper limit of the content of 3-methylbutanal in the flavor composition of the present invention, it is preferred in terms of flavor balance and cost effectiveness that the content be 300 ppb or lower, more preferably 100 ppb or lower, even more preferably 50 ppb or lower, and particularly preferably 10 ppb or lower.

The 3-methylbutanal of the present invention may be either synthetically produced or derived from, for example, food, beverage or extract which contains 3-methylbutanal as one of its components.

The amount of 3-methylbutanal contained in the flavor composition may be determined using gas chromatography SPME (solid phase microextraction) based on a method, called the standard addition method, to be explained in the following.

First, 3-methylbutanal is added to samples (flavor compositions) so that they have concentrations of 0.01 ppm, 0.1 ppm, 0.5 ppm, 1 ppm, 10 ppm, and 50 ppm to prepare standard samples. They are subjected to gas chromatography in addition to the flavor compositions, and the peak area of ion mass 44 (molecular ion) is measured to create a calibration curve. The retention time is also recorded. The resultant calibration curve may be used to determine the content of 3-methylbutanal in the flavor composition.

### (5-Hydroxymethylfurfural)

It is preferred that the flavor composition of the present invention contain not only methyl 2-methyl-3-furyl disulfide and 2-acetylpyrrole but also 5-hydroxymethylfurfural (Chemical formula: C₆H₆O₃, CAS No.: 67-47-0). 5-hydroxymethylfurfural is also termed 5-(hydroxymethyl)-2-furaldehyde.

The 5-hydroxymethylfurfural according to the present invention may further enhance the meaty flavor without impairing the flavor of grilled chicken skin that is brought by methyl 2-methyl-3-furyl disulfide and 2-acetylpyrrole.

The flavor composition of the present invention may contain any amount of 5-hydroxymethylfurfural, which can be suitably adjusted according to, for example, an intended concentration of the flavor.

Regarding the lower limit of the content of 5-hydroxymethylfurfural in the flavor composition of the present invention, it is preferred in terms of sufficiently imparting the meaty flavor that the content be 0.001 ppb or higher, more preferably 0.01 ppb or higher, even more preferably 0.1 ppb or higher, particularly preferably 1 ppb or higher, and more particularly preferably 10 ppb or higher.

Regarding the upper limit of the content of 5-hydroxymethylfurfural in the flavor composition of the present invention, it is preferred in terms of preventing production of burnt odor in the flavor composition that the content be 10 ppb or lower, more preferably 5 ppb or lower, even more preferably 1 ppb or lower, and particularly preferably 0.1 ppb or lower. When a burnt odor occurs, it tends to be difficult to sense the flavor of grilled chicken skin and the meaty flavor.

The 5-hydroxymethylfurfural of the present invention may be either synthetically produced or derived from, for example, food, beverage or extract which contains 5-hydroxymethylfurfural as one of its components.

The amount of 5-hydroxymethylfurfural contained in the flavor composition may be determined using gas chromatography SPME (solid phase microextraction) based on a method, called the standard addition method, to be explained in the following.

First, 5-hydroxymethylfurfural is added to samples (flavor compositions) so that they have concentrations of 0.01 ppm, 0.1 ppm, 0.5 ppm, 1 ppm, 10 ppm, and 50 ppm to prepare standard samples. They are subjected to gas chromatography in addition to the flavor compositions, and the peak area of ion mass 97.0 (molecular ion) is measured to create a calibration curve. The retention time is also recorded. The resultant calibration curve may be used to determine the content of 5-hydroxymethylfurfural in the flavor composition.

### (Ratio Between Respective Aroma Contents)

The flavor composition of the present invention essentially contains methyl 2-methyl-3-furyl disulfide and 2-acetylpyrrole but the other compositions are not particularly limited.

The flavor composition of the present invention may contain not only the above-mentioned components but also at least one component selected from the group consisting of (i) 2-methylbutanal, (ii) 3-methylbutanal, and (iii) 5-hydroxymethylfurfural in respect of more effectively exerting the advantageous effects of the present invention. The flavor composition of the present invention contains preferably at least one of, more preferably two of, and even more preferably all the components (i), (ii), and (iii).

The flavor composition of the present invention may have the respective components at ratios which satisfy any one or more or all of the following. It is preferred in terms of more effectively exerting the advantageous effects of the present invention that the respective components satisfy ratios as specified below.

Regarding the lower limit of the mass ratio of the content of 2-acetylpyrrole to the content of methyl 2-methyl-3-furyl disulfide (2-acetylpyrrole/methyl 2-methyl-3-furyl disulfide), the ratio is 0.001 or higher, preferably 0.01 or higher, more preferably 0.1 or higher, even more preferably 1 or higher, and particularly preferably 3 or higher. Regarding the upper limit of the mass ratio (2-acetylpyrrole/methyl 2-methyl-3-furyl disulfide), the ratio is 1000 or lower, preferably 500 or lower, more preferably 100 or lower, and even more preferably 50 or lower.

Regarding the lower limit of the mass ratio of the content of 2-methylbutanal to the content of methyl 2-methyl-3-furyl disulfide (2-methylbutanal/methyl 2-methyl-3-furyl disulfide), it is preferred that the ratio be 0.1 or higher, more preferably 0.5 or higher, even more preferably 1 or higher, and particularly preferably 10 or higher. Regarding the upper limit of the mass ratio (2-methylbutanal/methyl 2-methyl-3-furyl disulfide), it is preferred that the ratio be 2,000 or lower, more preferably 1,000 or lower, even more preferably 500 or lower, and particularly preferably 200 or lower.

Regarding the lower limit of the mass ratio of the content of 3-methylbutanal to the content of methyl 2-methyl-3-furyl disulfide (3-methylbutanal/methyl 2-methyl-3-furyl disulfide), it is preferred that the ratio be 0.1 or higher, more preferably 0.5 or higher, even more preferably 1 or higher, and particularly preferably 10 or higher. Regarding the upper limit of the mass ratio (3-methylbutanal/methyl 2-methyl-3-furyl disulfide), it is preferred that the ratio be 2,000 or lower, more preferably 1,000 or lower, even more preferably 500 or lower, and particularly preferably 200 or lower.

Regarding the lower limit of the mass ratio of the content of 5-hydroxymethylfurfural to the content of methyl 2-methyl-3-furyl disulfide (5-hydroxymethylfurfural/methyl 2-methyl-3-furyl disulfide), it is preferred that the ratio be 0.005 or higher, more preferably 0.01 or higher, even more preferably 0.05 or higher, and particularly preferably 0.1 or higher. Regarding the upper limit of the mass ratio (5-hydroxymethylfurfural/methyl 2-methyl-3-furyl disulfide), it is preferred that the ratio be 250 or lower, more preferably 200 or lower, even more preferably 100 or lower, particularly preferably 50 or lower, and more particularly preferably 10 or lower.

Regarding the lower limit of the mass ratio of the content of 2-methylbutanal to the content of 2-acetylpyrrole (2-methylbutanal/2-acetylpyrrole), it is preferred that the ratio be 0.0005 or higher, more preferably 0.001 or higher, even more preferably 0.005 or higher, and particularly preferably 0.01 or higher. Regarding the upper limit of the mass ratio (2-methylbutanal/2-acetylpyrrole), it is preferred that the ratio be 500 or lower, more preferably 100 or lower, even more preferably 50 or lower, and particularly preferably 10 or lower.

Regarding the lower limit of the mass ratio of the content of 3-methylbutanal to the content of 2-acetylpyrrole (3-methylbutanal/2-acetylpyrrole), it is preferred that the ratio be 0.0005 or higher, more preferably 0.001 or higher, even more preferably 0.005 or higher, and particularly preferably 0.01 or higher. Regarding the upper limit of the mass ratio (3-methylbutanal/2-acetylpyrrole), it is preferred that the ratio be 500 or lower, more preferably 100 or lower, even more preferably 50 or lower, and particularly preferably 10 or lower.

Regarding the lower limit of the mass ratio of the content of 5-hydroxymethylfurfural to the content of 2-acetylpyrrole (5-hydroxymethylfurfural/2-acetylpyrrole), it is preferred that the ratio be 0.0005 or higher, more preferably 0.001 or higher, even more preferably 0.005 or higher, and particularly preferably 0.01 or higher. Regarding the upper limit of the mass ratio (5-hydroxymethylfurfural/2-acetylpyrrole), it is preferred that the ratio be 10 or lower, more preferably 1 or lower, even more preferably 0.5 or lower, and particularly preferably 0.1 or lower.

Regarding the lower limit of the mass ratio of the content of 3-methylbutanal to the content of 2-methylbutanal (3-methylbutanal/2-methylbutanal), it is preferred that the ratio be 0.01 or higher, more preferably 0.05 or higher, even more preferably 0.1 or higher, and particularly preferably 0.5 or higher. Regarding the upper limit of the mass ratio (3-methylbutanal/2-methylbutanal), it is preferred that the ratio be 500 or lower, more preferably 100 or lower, even more preferably 50 or lower, and particularly preferably 10 or lower.

Regarding the lower limit of the mass ratio of the content of 5-hydroxymethylfurfural to the content of 2-methylbutanal (5-hydroxymethylfurfural/2-methylbutanal), it is preferred that the ratio be 0.0001 or higher, more preferably 0.0005 or higher, even more preferably 0.001 or higher, and particularly preferably 0.005 or higher. Regarding the upper limit of the mass ratio (5-hydroxymethylfurfural/2-methylbutanal), it is preferred that the ratio be 1 or lower, more preferably 0.5 or lower, even more preferably 0.1 or lower, and particularly preferably 0.05 or lower.

Regarding the lower limit of the mass ratio of the content of 5-hydroxymethylfurfural to the content of 3-methylbutanal (5-hydroxymethylfurfural/3-methylbutanal), it is preferred that the ratio be 0.0001 or higher, more preferably 0.0005 or higher, even more preferably 0.001 or higher, and particularly preferably 0.005 or higher. Regarding the upper limit of the mass ratio (5-hydroxymethylfurfural/3-methylbutanal), it is preferred that the ratio be 1 or lower, more preferably 0.5 or lower, even more preferably 0.1 or lower, and particularly preferably 0.05 or lower.

### <Further Ingredient>

The flavor composition according to the present invention may contain, as a further ingredient, a food product or additive which is publicly known and blended to, for example, a food or beverage as far as the further ingredient does not impede the technical advantages of the present invention.

The further ingredient as used herein is not particularly limited and may contain an animal-based ingredient (e.g., animal meat, an ingredient originated from animal meat, animal oil or fat, a milk constituent, egg, etc.). However, in the spirit of the present invention which is advantageous for imparting a meaty flavor without containing any animal-based ingredient, it is preferred in terms of adapting to the sustainable food production system that a lesser animal-based ingredient, particularly preferably no animal-based ingredient, be contained therein.

Examples of the food products to be contained therein as such further ingredient include oils/fats, sugars, grains and their processed products, vegetables, fruits, spices, yeasts, yeast extracts, protein hydrolysates, flavored oils (such as green onion oil, hot sesame, huajiao oil, onion oil, garlic oil, ginger oil, mushroom oil, porcini oil, truffle oil, bamboo shoot oil, wasabi oil, yuzu citrus oil and roasted soy sauce oil), virgin coconut oil, virgin olive oil, virgin corn oil and smoked oil.

Examples of the food additive to be contained therein as such further ingredient include emulsifiers, antioxidants, silicones, pigments, flavoring agents, vitamins, and pH adjusters.

It is preferred that the flavor composition of the present invention further contain an oil/fat. An edible oil/fat is normally used for the oil/fat. Examples of such oil/fat include vegetable oils, animal oils/fats, synthetic oils/fats, and processed oils/fats. They may be used alone or as a blended oil in combination with two or more types of oils/fats.

Examples of the vegetable oils include, a rapeseed oil, a coconut oil, a palm oil, a sunflower oil, a soybean oil, a corn oil, a sesame oil, a perilla oil, a flaxseed oil, a peanut oil, a safflower oil, a high oleic safflower oil, a high oleic sunflower oil, a cottonseed oil, a grape seed oil, a macadamia nut oil, a hazelnut oil, a pumpkin seed oil, a walnut oil, a camellia oil, a tea seed oil, a perilla oil, a borage oil, an olive oil, a rice bran oil, a wheat germ oil, a cocoa fat, a palm kernel oil and an algae oil.

Examples of the animal oils/fats include a fish oil (an oil/fat derived from, for example, tuna, mackerel, sardines, bonito, and herring), pork fat, beef fat, milkfat, sheep fat and chicken oil.

Examples of the synthetic oils/fats include a medium chain triglyceride and diacylglycerol.

The processed oils/fats may be oils/fats where any of the above-listed oils/fats are subjected to desired processing. Examples of such processing include fractionation (such as fractionations of, for example, fractionated milkfat low melting point portion and palm super olein), hardening and ester exchange reaction. The oils/fats may be subjected to one or more processings.

As to the flavor composition of the present invention, the melting points of the oils/fats are preferably 50° C. or less for the above-explained aroma components to impart sufficient flavor to an oil/fat. Among them, an oil/fat in liquid state at room temperature (25° C.) may preferably be used.

It is preferred in terms of providing sufficient fluidity that flavor composition according to the present invention contain an oil-soluble ingredient in an amount of, although not particularly limited to the following, 50% by mass or higher, more preferably 60% by mass or higher, and even more preferably 70% by mass or higher, based on the total weight of the flavor composition. The term “oil-soluble ingredient” as used herein refers to an oil/fat and an ingredient soluble in the oil/fat.

The types and amounts of the above-listed food products and food additives can be set appropriately according to, for example, the effects to be achieved. These food products and food additives, when blended into the flavor composition of the present invention, enable it to achieve, for example, the effects of adjusting flavor and color, inhibiting oxidative deterioration, and improving functionality.

In terms of improving shelf life, it is preferred that the moisture content of the flavor composition according to the present invention be 5.0% by mass or less, more preferably 3.0% by mass or less, even more preferably 1.0% by mass or less, and particularly more preferably 0.5% by mass or less based on the total weight of the flavor composition. Note that the moisture content of the flavor composition as used herein refers not only to the water blended in the flavor composition, but also to any other moisture content transferred from the raw ingredients other than the water originally blended in the flavor composition.

The moisture content of the flavor composition of the present invention may be measured by the “Standard methods for the Analysis of Fats and oils and related chemistry, 2.1.3.4-2013, Moisture Content (Karl Fischer Method)”.

In terms of allowing the advantageous effects of the present invention to be easily exerted, the flavor composition of the present invention may consist only of the above two components (methyl 2-methyl-3-furyl disulfide and 2-acetylpyrrole), where no other components are contained therein.

### <Method for Manufacturing Flavor Composition>

The respective ingredients are appropriately mixed and stirred using, for example, a stirrer to allow the production of the flavor composition of the present invention. The mixing order of the ingredients is not particularly limited.

The above-explained aroma components (i.e., methyl 2-methyl-3-furyl disulfide, 2-acetylpyrrole, 2-methylbutanal, 3-methylbutanal, and 5-hydroxymethylfurfural) may be either synthetically produced or contained in the flavor composition as food, beverage or extract that contains the component(s) as one of its components. Examples of such synthetic products include a reagent or fragrance that is commercially available.

A food product and a food additive containing some or all of the aroma components mentioned above may also be used as an ingredient of the flavor composition that contains some or all of the components. Examples of such food product and such food additive include animal meats, saccharides, grains, vegetables (e.g., green onion, onion, celery, carrot), fruits (e.g., banana, lemon, melon, strawberry, coconut), soy sauce, miso, spices (e.g., anise, allspice, caraway, cumin, clove, coriander, cinnamon, star anise, sage, thyme, nutmeg, basil, paprika, pimento, pink pepper, black pepper, white pepper, mace, lemongrass, rose hip, rosemary, laurel), flavored edible oils (e.g., green onion oil, hot sesame oil, huajiao oil, onion oil, garlic oil, ginger oil, mushroom oil, porcini mushroom oil, truffle oil, bamboo shoot oil, wasabi oil, yuzu citrus oil, roasted soy sauce oil), virgin coconut oil, virgin olive oil, virgin corn oil, smoked liquid, smoked oil, yeasts, yeast extracts, protein hydrolysates, peptides, amino acids, nucleic acids, vitamins, minerals, and any combination thereof.

The food product may be used directly without being processed or may be used after being processed (e.g., heated). For example, the food product may be added in an oil and/or fat, followed by heating, filtration, and/or other steps, so that the flavor composition of the present invention is obtained.

### <Use of Flavor Composition>

The oil and/or fat composition of the present invention may be used for any purpose, such as a seasoning oil or an alternative to an animal fat/oil known in the art, or may be used in combination with any seasoning (e.g., seasoning oil known in the art).

The flavor composition of the present invention may be added to any food or beverage product and give a good meaty flavor to the food or beverage product to which the composition is added.

Therefore, the present invention also encompasses food and beverage products (preferably meat alternative food products) containing the flavor composition of the present invention.

Examples of food and beverage products to which the flavor composition of the present invention may be added include, but are not particularly limited to: various types of cooked foods (such as stir-fried dishes including fried rice, pilaf, and pan-fried noodles); grilled items (such as chicken skewer, tsukune meatballs, minced meat, grilled meat, gyoza, meat patties, and gratin); boiled dishes (such as udon noodles, soba noodles, ramen, and pasta); steamed foods (such as shumai and Chinese buns); fried food items (such as croquettes, fried chicken, and tempura); salad chicken; curry; confectionery; bread; soups (such as white broth soup); and sauces (such as pasta sauce).

The flavor composition of the present invention may be directly added to a food or beverage product. Alternatively, the flavor composition of the present invention may be added to any type of oil and/or fat products (such as frying oil, margarine, fat spread, shortening, edible oil/fat, flavored edible oil, oil-in-water emulsion product (e.g., concentrated milk, whipping cream, or mayonnaise), powdered oil/fat, or dressing), after which those products may be used as raw materials for food or beverage products.

It is preferred in terms of imparting sufficient meaty flavor to a food or beverage that the flavor composition produced according to the present invention be contained in the food or beverage in an amount of 0.10% by mass or higher, more preferably of 0.50% by mass or higher, even more preferably of 1.0% by mass or higher, particularly preferably of 3.0% by mass or higher, and more particularly preferably of 5.0% by mass or higher based on the whole mass of the food or beverage. The flavor composition produced according to the present invention may be contained in a food or beverage in any amount whose upper limit is not particularly limited but it is preferred that the flavor composition be contained therein in an amount of 40% by mass or lower, more preferably of 35% by mass or lower, even more preferably of 30% by mass or lower, particularly preferably of 25% by mass or lower, and more particularly preferably of 20% by mass or lower.

As mentioned above, the present invention makes it possible to provide a favorable flavor of grilled chicken skin without formulating any animal-derived ingredients.

Accordingly, the present invention makes it possible to give a good flavor of grilled chicken skin to, for example, meat alternative food products.

The present invention also makes it possible to not only provide meat alternative food products with a good flavor of grilled chicken skin but also mask material-specific odors (e.g., beany flavor in soybeans).

The term “meat alternative food product” as used herein is intended to include any food products produced using a vegetable raw material (such as beans (e.g., soybeans, peas, chickpeas, horse beans), rice, or grains) as a main raw material.

In respect of effectively achieving the advantageous effects of the present invention, the meat alternative food product according to the present invention is preferably free of any animal-derived ingredient (e.g., animal meat, meat-derived components, animal oil/fat, milk constituents, egg).

Examples of the meat alternative food product include tofu patty and vegetable protein processed foods (chicken skewer-like foods, tsukune meatball-like foods, minced meat-like foods, salad chicken-like foods, meat patty-like foods, shumai-like foods, gyoza-like foods, Chinese bun-like foods, fillet meat-like foods (grilled meat, stir-fried foods), pasta sauce, and keema curry).

### EXAMPLES

The present invention will be described in greater detail hereunder with reference to working examples; the invention shall not be limited to the following working examples.

### <Test 1: Preparation and Evaluation of Flavor Composition>

The methods as explained below were used to prepare flavor compositions, and their flavors were evaluated.

### (Preparation of Flavor Composition)

The respective components were mixed and stirred such that the amounts of respective components to the oils/fats indicated in the section of “oil/fat” in Tables 1A and 1B are at concentrations (in terms of ppm) indicated in the sections of “Contents thereof in flavor composition” to prepare the flavor compositions of the working and comparative examples. The flavor compositions of Working Examples 15, 16, and 17 were produced by adding a yeast extract, a protein hydrolysate, and a grain processed product to a rapeseed oil, followed by heating them, and then removing the solid contents. The concentrations shown in the section of “Contents thereof in flavor composition” indicate values determined using gas chromatography SPME (solid phase microextraction) for the flavor composition.

The wording “Mass ratio thereof to methyl 2-methyl-3-furyl disulfide” as used in FIGS. 1A and 1B refers to the mass ratios (respective aroma components/methyl 2-methyl-3-furyl disulfide) of the contents of the respective aroma components shown in FIGS. 1A and 1B, other than methyl 2-methyl-3-furyl disulfide, to the content of methyl 2-methyl-3-furyl disulfide in the respective flavor compositions.

The wording “Mass ratio thereof to 2-acetylpyrrole” as used herein refers to the mass ratios (respective aroma components/2-acetylpyrrole) of the contents of the respective aroma components shown in FIGS. 1A and 1B, other than 2-acetylpyrrole, to the content of 2-acetylpyrrole in the respective flavor compositions.

The wording “Mass ratio thereof to 2-methylbutanal” as used herein refers to the mass ratios (respective aroma components/2-methylbutanal) of the contents of the respective aroma components shown in FIGS. 1A and 1B, other than 2-methylbutanal, to the content of 2-methylbutanal in the respective flavor compositions.

The wording “Mass ratio thereof to 3-methylbutanal” as used herein refers to the mass ratios (respective aroma components/3-methylbutanal) of the contents of the respective aroma components shown in FIGS. 1A and 1B, other than 3-methylbutanal, to the content of 3-methylbutanal in the respective flavor compositions.

The wording “Mass ratio thereof to 5-hydroxymethylfurfural” as used herein refers to the mass ratios (respective aroma components/5-hydroxymethylfurfural) of the contents of the respective aroma components shown in FIGS. 1A and 1B, other than 5-hydroxymethylfurfural, to the content of 5-hydroxymethylfurfural in the respective flavor compositions.

### (Evaluation of Flavor Composition)

The resultant flavor compositions were used to perform sensory evaluations respectively on the flavor of grilled chicken skin, the chicken scent, and the meaty flavor based on the following. The results are as shown in the section of “Evaluation” in FIGS. 1A and 1B.

The sensory evaluations were carried out by the panels selected in a way as explained below. Panel candidates were given a flavor discrimination test for the five primary tastes (sweetness, sourness, saltiness, bitterness, and umami), a taste intensity difference discrimination test, a taste discrimination test for food products, and a standard smell test to select twelve people as the panels who were determined as suitable in all of these tests.

To carry out the evaluation, the whole members of the panel had a discussion to get alignment on the characteristics of each evaluation item to ensure that the whole members of the panel have a common understanding of the criteria. In order to eliminate the bias of the panels in the sensory evaluation and to improve the accuracy of the evaluation, the test section ID numbers and contents of the samples were not disclosed to the panel, and the samples were randomly presented.

### [Sensory Evaluation]

The flavor composition as outlined in Tables 1A and 1B were subjected to the sensory evaluations by twelve panels to determine the perceived intensities of the “flavor of grilled chicken skin”, “chicken scent”, and “meaty flavor” during the tasting on the basis of the number of people who felt more intense flavor than Comparative Example 1 in each item, and were evaluated using the following criteria. The grades greater than “◯” were determined as passing grades, while the grade “x” was determined as the one incapable of solving the object of the present invention. The results are as shown in the section of “Evaluation” in Tables 1A and 1B.

### Evaluation Criteria for Flavor of Grilled Chicken Skin

⊚++: Among the 12 panels, 10 or more panels responded that they felt a more intense sensory stimulus than the reference example.

⊚+: Among the 12 panels, 9 panels responded that they felt a more intense sensory stimulus than the reference example.

⊚: Among the 12 panels, 8 panels responded that they felt a more intense sensory stimulus than the reference example.

◯: Among the 12 panels, 7 panels responded that they felt a more intense sensory stimulus than the reference example.

x: Among the 12 panels, panels of less than or equal to 6 people responded that they felt a more intense sensory stimulus than the reference example.

### Evaluation Criteria for Chicken Scent

⊚++: Among the 12 panels, 10 or more panels responded that they felt a more intense sensory stimulus than the reference example

⊚+: Among the 12 panels, 9 panels responded that they felt a more intense sensory stimulus than the reference example

⊚: Among the 12 panels, 8 panels responded that they felt a more intense sensory stimulus than the reference example

◯: Among the 12 panels, 7 panels responded that they felt a more intense sensory stimulus than the reference example

X: Among the 12 panels, panels of less than or equal to 6 people responded that they felt a more intense sensory stimulus than the reference example.

### Evaluation Criteria for Meaty Flavor

⊚+++: Among the 12 panels, 11 panels responded that they felt a more intense sensory stimulus than the reference example

⊚++: Among the 12 panels, 10 panels responded that they felt a more intense sensory stimulus than the reference example

⊚+: Among the 12 panels, 9 panels responded that they felt a more intense sensory stimulus than the reference example

⊚: Among the 12 panels, 8 panels responded that they felt a more intense sensory stimulus than the reference example

◯: Among the 12 panels, 7 panels responded that they felt a more intense sensory stimulus than the reference example

x: Among the 12 panels, panels of less than or equal to 6 people responded that they felt a more intense sensory stimulus than the reference example.

TABLE 1A

| | | Working | Working | Working | Working | Working |
|---|---|---|---|---|---|---|
| | | Example | Example | Example | Example | Example |
| | | 1 | 2 | 3 | 4 | 5 |
| Oil/fat | Rapeseed oil | 100 | 100 | 100 | 100 | 100 |
| | Palm oil | | | | | |
| Contents thereof in flavor | Methyl 2-methyl-3-furyl disulfide | 1.0 | 0.0010 | 0.10 | 0.10 | 0.10 |
| composition (ppm) | 2-acetylpyrrole | 0.0010 | 1.0 | 0.010 | 0.10 | 1.0 |
| | 2-methylbutanal | | | | | |
| | 3-methylbutanal | | | | | |
| | 5-hydroxymethylfurfural | | | | | |
| Mass ratio thereof to methyl | 2-acetylpyrrole | 0.001 | 1000 | 0.1 | 1 | 10 |
| 2-methyl-3-furyl disulfide | 2-methylbutanal | 0 | 0 | 0 | 0 | 0 |
| | 3-methylbutanal | 0 | 0 | 0 | 0 | 0 |
| | 5-hydroxymethylfurfural | 0 | 0 | 0 | 0 | 0 |
| Mass ratio thereof to 2- | 2-methylbutanal | 0 | 0 | 0 | 0 | 0 |
| acetylpyrrole | 3-methylbutanal | 0 | 0 | 0 | 0 | 0 |
| | 5-hydroxymethylfurfural | 0 | 0 | 0 | 0 | 0 |
| Mass ratio thereof to 2- | 3-methylbutanal | — | — | — | — | — |
| methylbutanal | 5-hydroxymethylfurfural | — | — | — | — | — |
| Mass ratio thereof to 3- | 5-hydroxymethylfurfural | — | — | — | — | — |
| methylbutanal | | | | | | |
| Evaluation | Flavor of grilled chicken skin | ◯ | ◯ | ⊚ | ⊚+ | ⊚++ |
| | Chicken scent | ◯ | ◯ | ◯ | ◯ | ◯ |
| | Meaty flavor | ◯ | ◯ | ⊚ | ⊚+ | ⊚++ |
| | | Working | Working | Working | Working | Working |
| | | Example | Example | Example | Example | Example |
| | | 6 | 7 | 8 | 9 | 10 |
| Oil/fat | Rapeseed oil | 100 | 100 | 100 | 100 | 100 |
| | Palm oil | | | | | |
| Contents thereof in flavor | Methyl 2-methyl-3-furyl disulfide | 0.10 | 0.10 | 0.10 | 0.10 | 0.10 |
| composition (ppm) | 2-acetylpyrrole | 1.0 | 1.0 | 1.0 | 1.0 | 1.0 |
| | 2-methylbutanal | 0.2 | 2.0 | 18 | 30 | |
| | 3-methylbutanal | | | | | 0.2 |
| | 5-hydroxymethylfurfural | | | | | |
| Mass ratio thereof to methyl | 2-acetylpyrrole | 10 | 10 | 10 | 10 | 10 |
| 2-methyl-3-furyl disulfide | 2-methylbutanal | 2 | 20 | 180 | 300 | 0 |
| | 3-methylbutanal | 0 | 0 | 0 | 0 | 2 |
| | 5-hydroxymethylfurfural | 0 | 0 | 0 | 0 | 0 |
| Mass ratio thereof to 2- | 2-methylbutanal | 0.20 | 2 | 18 | 30 | 0 |
| acetylpyrrole | 3-methylbutanal | 0 | 0 | 0 | 0 | 0.20 |
| | 5-hydroxymethylfurfural | 0 | 0 | 0 | 0 | 0 |
| Mass ratio thereof to 2- | 3-methylbutanal | 0 | 0 | 0 | 0 | — |
| methylbutanal | 5-hydroxymethylfurfural | 0 | 0 | 0 | 0 | — |
| Mass ratio thereof to 3- | 5-hydroxymethylfurfural | — | — | — | — | 0 |
| methylbutanal | | | | | | |
| Evaluation | Flavor of grilled chicken skin | ⊚++ | ⊚++ | ⊚++ | ⊚++ | ⊚++ |
| | Chicken scent | ⊚+ | ⊚++ | ⊚++ | ⊚+ | ⊚+ |
| | Meaty flavor | ⊚++ | ⊚++ | ⊚++ | ⊚++ | ⊚++ |

TABLE 1B

| | | Working | Working | Working | Working | Working |
|---|---|---|---|---|---|---|
| | | Example 11 | Example 12 | Example 13 | Example 14 | Example 15 |
| Oil/fat | Rapeseed oil | 100 | 100 | | 100 | 100 |
| | Palm oil | | | 100 | | |
| Contents thereof in flavor | Methyl 2-methyl-3-furyl disulfide | 0.10 | 0.10 | 0.10 | 0.10 | 0.14 |
| composition (ppm) | 2-acetylpyrrole | 1.0 | 1.0 | 1.0 | 1.0 | 1.0 |
| | 2-methylbutanal | | | | | 4.1 |
| | 3-methylbutanal | 2.0 | 18 | 18 | 30 | 5.5 |
| | 5-hydroxymethylfurfural | | | | | 0.070 |
| Mass ratio thereof to methyl | 2-acetylpyrrole | 10 | 10 | 10 | 10 | 7.1 |
| 2-methyl-3-furyl disulfide | 2-methylbutanal | 0 | 0 | 0 | 0 | 29 |
| | 3-methylbutanal | 20 | 180 | 180 | 300 | 39 |
| | 5-hydroxymethylfurfural | 0 | 0 | 0 | 0 | 0.50 |
| Mass ratio thereof to 2- | 2-methylbutanal | 0 | 0 | 0 | 0 | 4.1 |
| acetylpyrrole | 3-methylbutanal | 2 | 18 | 18 | 30 | 5.5 |
| | 5-hydroxymethylfurfural | 0 | 0 | 0 | 0 | 0.070 |
| Mass ratio thereof to 2- | 3-methylbutanal | — | — | — | — | 1.3 |
| methylbutanal | 5-hydroxymethylfurfural | — | — | — | — | 0.017 |
| Mass ratio thereof to 3- | 5-hydroxymethylfurfural | 0 | 0 | 0 | 0 | 0.013 |
| methylbutanal | | | | | | |
| Evaluation | Flavor of grilled chicken skin | ⊚++ | ⊚++ | ⊚+ | ⊚++ | ⊚++ |
| | Chicken scent | ⊚++ | ⊚++ | ⊚+ | ⊚+ | ⊚++ |
| | Meaty flavor | ⊚++ | ⊚++ | ⊚+ | ⊚++ | ⊚+++ |

| | | Working | Working | Comparative | Comparative |
|---|---|---|---|---|---|
| | | Example 16 | Example 17 | Example 1 | Example 2 |
| Oil/fat | Rapeseed oil | 100 | 100 | | |
| | Palm oil | | | | |
| Contents thereof in flavor | Methyl 2-methyl-3-furyl disulfide | 0.014 | 0.056 | 1.0 | 0.0010 |
| composition (ppm) | 2-acetylpyrrole | 0.36 | 12 | 0.00050 | 2.0 |
| | 2-methylbutanal | 1.4 | 1.4 | | |
| | 3-methylbutanal | 1.7 | 3.9 | | |
| | 5-hydroxymethylfurfural | 0.020 | 14 | | |
| Mass ratio thereof to methyl | 2-acetylpyrrole | 25 | 214 | 0.0005 | 2000 |
| 2-methyl-3-furyl disulfide | 2-methylbutanal | 98 | 25 | 0 | 0 |
| | 3-methylbutanal | 120 | 70 | 0 | 0 |
| | 5-hydroxymethylfurfural | 1.4 | 250 | 0 | 0 |
| Mass ratio thereof to 2- | 2-methylbutanal | 3.9 | 0.12 | 0 | 0 |
| acetylpyrrole | 3-methylbutanal | 4.8 | 0.33 | 0 | 0 |
| | 5-hydroxymethylfurfural | 0.056 | 1.2 | 0 | 0 |
| Mass ratio thereof to 2- | 3-methylbutanal | 1.2 | 2.8 | — | — |
| methylbutanal | 5-hydroxymethylfurfural | 0.014 | 10 | — | — |
| Mass ratio thereof to 3- | 5-hydroxymethylfurfural | 0.012 | 3.6 | — | — |
| methylbutanal | | | | | |
| Evaluation | Flavor of grilled chicken skin | ⊚++ | ⊚ | — | X |
| | Chicken scent | ⊚++ | ⊚++ | — | X |
| | Meaty flavor | ⊚+++ | ⊚ | — | X |

### <Test 2: Preparation and Evaluation of Chicken Meat Ball>

Chicken meat balls were prepared following the procedure explained below. The formulations of the flavor compositions used for the chicken meat balls are as shown in Table 2.

1) 20% by mass of a flavor composition selected from any one of Working example 15, Comparative example 1, and Comparative example 2, 30% by mass of rapeseed oil, and 50% by mass of palm fraction soft oil (Iodine value of 56) were mixed together to prepare a flavor composition for chicken meat ball.

2) 20 g of powdered soy protein, 7 g of methylcellulose, 2 g of salt, and 16 g of rapeseed oil were mixed, to which 155 g of ice water was added and thoroughly stirred using a cutter mixer to prepare a soybean curd.

3) 12 g of powdered soy protein, 20 g of water, 4 g of soy sauce, and 2 g of ginger were mixed with each other to hydrate the powdered soy protein.

4) 24 g of onion (frozen and diced) and 6 g of modified starch were mixed with each other.

5) 8 g of breadcrumbs, 0.8 g of salt and 0.2 g of black pepper were mixed with each other.

6) 3) and 4) were mixed into 5)

7) 16 g of 1) was mixed into 6)

8) 107 g of 2) was added to 7), which was kneaded well until it became sticky to make a dough.

9) The dough was formed into respective 50 g portions, which were baked for 15 minutes in a convection oven set at 195° C. After the baking, each portion was cut in half to subject them to the examination.

### [Sensory Evaluation]

The prepared chicken meat balls were subjected to the sensory evaluations by twelve panels to evaluate the perceived intensities of the “flavor of grilled chicken skin”, “chicken scent”, “meaty flavor”, and “beany odor masking effect” during the tasting on the basis of the number of people who felt more intense flavor (or weaker beany odor in the case for masking beany odor) than Comparative Example 3 in each item, and were evaluated using the following criteria. The results are as shown in the section of “Evaluation” in Table 2.

### Evaluation Criteria for Flavor of Grilled Chicken Skin

⊚++: Among the 12 panels, 10 or more panels responded that they felt a more intense sensory stimulus than the reference example

⊚+: Among the 12 panels, 9 panels responded that they felt a more intense sensory stimulus than the reference example

⊚: Among the 12 panels, 8 panels responded that they felt a more intense sensory stimulus than the reference example

◯: Among the 12 panels, 7 panels responded that they felt a more intense sensory stimulus than the reference example

x: Among the 12 panels, panels of less than or equal to 6 people responded that they felt a more intense sensory stimulus than the reference example.

### Evaluation Criteria for Chicken Scent

⊚++: Among the 12 panels, 10 or more panels responded that they felt a more intense sensory stimulus than the reference example

⊚+: Among the 12 panels, 9 panels responded that they felt a more intense sensory stimulus than the reference example

⊚: Among the 12 panels, 8 panels responded that they felt a more intense sensory stimulus than the reference example

◯: Among the 12 panels, 7 panels responded that they felt a more intense sensory stimulus than the reference example

x: Among the 12 panels, panels of less than or equal to 6 people responded that they felt a more intense sensory stimulus than the reference example.

### Evaluation Criteria for Meaty Flavor

⊚+++: Among the 12 panels, 11 panels responded that they felt a more intense sensory stimulus than the reference example

⊚++: Among the 12 panels, 10 panels responded that they felt a more intense sensory stimulus than the reference example

⊚+: Among the 12 panels, 9 panels responded that they felt a more intense sensory stimulus than the reference example

⊚: Among the 12 panels, 8 panels responded that they felt a more intense sensory stimulus than the reference example

◯: Among the 12 panels, 7 panels responded that they felt a more intense sensory stimulus than the reference example

x: Among the 12 panels, panels of less than or equal to 6 people responded that they felt a more intense sensory stimulus than the reference example.

### Evaluation Criteria for Masking Beany Odor:

⊚++: Among the 12 panels, 10 or more panels responded that they felt a weaker beany odor than the reference example

⊚+: Among the 12 panels, 9 panels responded that they felt a weaker beany odor than the reference example

⊚: Among the 12 panels, 8 panels responded that they felt a weaker beany odor than the reference example

◯: Among the 12 panels, 7 panels responded that they felt a weaker beany odor than the reference example

x: Among the 12 panels, panels of less than or equal to 6 people responded that they felt a weaker beany odor than the reference example

TABLE 2

| | | Working | Compar- | Compar- |
|---|---|---|---|---|
| | | Example | ative | ative |
| | | 18 | Example 3 | Example 4 |
| Flavor | Product of Working | 20 | | |
| composition | Example 15 | | | |
| for chicken | Product of | | 20 | |
| meat ball | Comparative | | | |
| | Example 1 | | | |
| | Product of | | | 20 |
| | Comparative | | | |
| | Example 2 | | | |
| | Rapeseed oil | 30 | 30 | 30 |
| | Palm fraction soft oil | 50 | 50 | 50 |
| Evaluation | Flavor of grilled | ⊚++ | — | X |
| | chicken skin | | | |
| | Chicken scent | ⊚++ | — | X |
| | Meaty flavor | ⊚+++ | — | X |
| | Masking of beany odor | ⊚++ | — | X |

### <Test 3: Preparation and Evaluation of Minced Soy Meat>

20% by mass of a flavor composition selected from any one of Working Example 16, Comparative Example 1, and Comparative Example 2, 35% by mass of rapeseed oil, and 45% by mass of palm oil were mixed together to prepare a flavor composition for minced soy meat.

50 g of granular soy protein, rehydrated with warm water, together with 7 g of the flavor composition for minced soy meat, were stir-fried for 1 minute on medium heat. Then, 5 g of Sake, 5 g of soy sauce, and 5 g of Mirin were further added thereto and stir-fried for another 4 minutes, which was subjected to the examination.

### [Sensory Evaluation]

The prepared minced soy meats were subjected to the sensory evaluations by twelve panels to evaluate the perceived intensities of the “flavor of grilled chicken skin”, “chicken scent”, “meaty flavor”, and “beany odor masking effect” during the tasting on the basis of the number of people who felt more intense flavor (or weaker beany odor in the case for masking beany odor) than Comparative Example 5 in each item, and were evaluated using the following criteria. The results are as shown in the section of “Evaluation” in Table 3.

### Evaluation Criteria for Flavor of Grilled Chicken Skin

⊚++: Among the 12 panels, 10 or more panels responded that they felt a more intense sensory stimulus than the reference example

⊚+: Among the 12 panels, 9 panels responded that they felt a more intense sensory stimulus than the reference example

⊚: Among the 12 panels, 8 panels responded that they felt a more intense sensory stimulus than the reference example

◯: Among the 12 panels, 7 panels responded that they felt a more intense sensory stimulus than the reference example

x: Among the 12 panels, panels of less than or equal to 6 people responded that they felt a more intense sensory stimulus than the reference example.

### Evaluation Criteria for Chicken Scent

⊚++: Among the 12 panels, 10 or more panels responded that they felt a more intense sensory stimulus than the reference example

⊚+: Among the 12 panels, 9 panels responded that they felt a more intense sensory stimulus than the reference example

⊚: Among the 12 panels, 8 panels responded that they felt a more intense sensory stimulus than the reference example

◯: Among the 12 panels, 7 panels responded that they felt a more intense sensory stimulus than the reference example

x: Among the 12 panels, panels of less than or equal to 6 people responded that they felt a more intense sensory stimulus than the reference example.

### Evaluation Criteria for Meaty Flavor

⊚+++: Among the 12 panels, 11 panels responded that they felt a more intense sensory stimulus than the reference example

⊚++: Among the 12 panels, 10 panels responded that they felt a more intense sensory stimulus than the reference example

⊚+: Among the 12 panels, 9 panels responded that they felt a more intense sensory stimulus than the reference example

⊚: Among the 12 panels, 8 panels responded that they felt a more intense sensory stimulus than the reference example

◯: Among the 12 panels, 7 panels responded that they felt a more intense sensory stimulus than the reference example

x: Among the 12 panels, panels of less than or equal to 6 people responded that they felt a more intense sensory stimulus than the reference example.

### Evaluation Criteria for Masking Beany Odor:

⊚++: Among the 12 panels, 10 or more panels responded that they felt a weaker beany odor than the reference example

⊚+: Among the 12 panels, 9 panels responded that they felt a weaker beany odor than the reference example

⊚: Among the 12 panels, 8 panels responded that they felt a weaker beany odor than the reference example

◯: Among the 12 panels, 7 panels responded that they felt a weaker beany odor than the reference example

x: Among the 12 panels, panels of less than or equal to 6 people responded that they felt a weaker beany odor than the reference example

TABLE 3

| | | Working | Compar- | Compar- |
|---|---|---|---|---|
| | | Example | ative | ative |
| | | 19 | Example 5 | Example 6 |
| Flavor | Product of Working | 20 | | |
| composition | Example 16 | | | |
| for minced | Product of | | 20 | |
| soy meat | Comparative | | | |
| | Example 1 | | | |
| | Product of | | | 20 |
| | Comparative | | | |
| | Example 2 | | | |
| | Rapeseed oil | 35 | 35 | 35 |
| | Palm oil | 45 | 45 | 45 |
| Evaluation | Flavor of grilled | ⊚++ | — | X |
| | chicken skin | | | |
| | Chicken scent | ⊚++ | — | X |
| | Meaty flavor | ⊚+++ | — | X |
| | Masking of beany odor | ⊚++ | — | X |

### <Test 4: Preparation and Evaluation of Soy Meat Chicken Skewer>

30% by mass of a flavor composition selected from any one of working example 15, Working Example 16, Working Example 17, Comparative Example 1, and Comparative example 2, 45% by mass of rapeseed oil, and 25% by mass of ester exchange oil of palm fraction soft oil (Iodine value of 56) were mixed together to prepare a flavor composition for soy meat chicken skewer.

2.5 g of the flavor composition for soy meat chicken skewer was heated in a frying pan on which granular soy protein (soy meat), rehydrated with warm water, was thread onto a skewer and heated on both sides of it using the frying pan. Next, the soy meat was roasted while gradually brushing on 8.3 g of sauce prepared by mixing 3.2 g of soy sauce, 2.2 g of starch syrup, 1.7 g of Mirin, and 1.2 g of Sake followed by boiling down the sauce until the sauce thickened, which was subjected to the examination.

### [Sensory Evaluation]

The prepared soy meat chicken skewers were subjected to the sensory evaluations by twelve panels to evaluate the perceived intensities of the “flavor of grilled chicken skin”, “chicken scent”, “meaty flavor”, and “beany odor masking effect” during the tasting on the basis of the number of people who felt more intense flavor (or weaker beany odor in the case for masking beany odor) than Comparative Example 7 in each item, and were evaluated using the following criteria. The results are as shown in the section of “Evaluation” in Table 4.

### Evaluation Criteria for Flavor of Grilled Chicken Skin

⊚++: Among the 12 panels, 10 or more panels responded that they felt a more intense sensory stimulus than the reference example

⊚+: Among the 12 panels, 9 panels responded that they felt a more intense sensory stimulus than the reference example

⊚: Among the 12 panels, 8 panels responded that they felt a more intense sensory stimulus than the reference example

◯: Among the 12 panels, 7 panels responded that they felt a more intense sensory stimulus than the reference example

x: Among the 12 panels, panels of less than or equal to 6 people responded that they felt a more intense sensory stimulus than the reference example.

### Evaluation Criteria for Chicken Scent

⊚++: Among the 12 panels, 10 or more panels responded that they felt a more intense sensory stimulus than the reference example

⊚+: Among the 12 panels, 9 panels responded that they felt a more intense sensory stimulus than the reference example

⊚: Among the 12 panels, 8 panels responded that they felt a more intense sensory stimulus than the reference example

◯: Among the 12 panels, 7 panels responded that they felt a more intense sensory stimulus than the reference example

x: Among the 12 panels, panels of less than or equal to 6 people responded that they felt a more intense sensory stimulus than the reference example

### Evaluation Criteria for Meaty Flavor

⊚+++: Among the 12 panels, 11 panels responded that they felt a more intense sensory stimulus than the reference example

⊚++: Among the 12 panels, 10 panels responded that they felt a more intense sensory stimulus than the reference example

⊚+: Among the 12 panels, 9 panels responded that they felt a more intense sensory stimulus than the reference example

⊚: Among the 12 panels, 8 panels responded that they felt a more intense sensory stimulus than the reference example

◯: Among the 12 panels, 7 panels responded that they felt a more intense sensory stimulus than the reference example

x: Among the 12 panels, panels of less than or equal to 6 people responded that they felt a more intense sensory stimulus than the reference example.

### Evaluation Criteria for Masking Beany Odor:

⊚++: Among the 12 panels, 10 or more panels responded that they felt a weaker beany odor than the reference example

⊚+: Among the 12 panels, 9 panels responded that they felt a weaker beany odor than the reference example:

⊚: Among the 12 panels, 8 panels responded that they felt a weaker beany odor than the reference example

◯: Among the 12 panels, 7 panels responded that they felt a weaker beany odor than the reference example

x: Among the 12 panels, panels of less than or equal to 6 people responded that they felt a weaker beany odor than the reference example

TABLE 4

| | | Working | Working | Working | Comparative | Comparative |
|---|---|---|---|---|---|---|
| | | Example 20 | Example 21 | Example 22 | Example 7 | Example 8 |
| Flavor composition for | Product of Working Example 15 | 30 | | | | |
| soy meat chicken | Product of Working Example 16 | | 30 | | | |
| skewer | Product of Working Example 17 | | | 30 | | |
| | Product of Comparative Example 1 | | | | 30 | |
| | Product of Comparative Example 2 | | | | | 30 |
| | Rapeseed oil | 45 | 45 | 45 | 45 | 45 |
| | Ester exchange oil of palm fraction soft oil | 25 | 25 | 25 | 25 | 25 |
| Evaluation | Flavor of grilled chicken skin | ⊚++ | ⊚++ | ⊚ | — | X |
| | Chicken scent | ⊚++ | ⊚++ | ⊚++ | — | X |
| | Meaty flavor | ⊚+++ | ⊚+++ | ⊚ | — | X |
| | Masking of beany odor | ⊚++ | ⊚++ | ⊚++ | — | X |

1. A flavor composition comprising methyl 2-methyl-3-furyl disulfide and 2-acetylpyrrole, wherein the mass ratio of the content of 2-acetylpyrrole to the content of methyl 2-methyl-3-furyl disulfide is from 0.001 to 1,000.

2. The flavor composition according to claim 1, further comprising 2-methylbutanal, wherein the mass ratio of the content of 2-methylbutanal to the content of methyl 2-methyl-3-furyl disulfide is from 0.1 to 2,000.

3. The flavor composition according to claim 1, further comprising 3-methylbutanal, wherein the mass ratio of the content of 3-methylbutanal to the content of methyl 2-methyl-3-furyl disulfide is from 0.1 to 2,000.

4. A food or beverage comprising the flavor composition according to claim 1.
